(19) United States
(12) Patent Application Publication
(10) Pub. No.: US 2020/0231845 A1
(43) Pub. Date: Jul. 23, 2020

(54) LIGHT DETECTABLE THERMAL-RELEASE PRESSURE-SENSITIVE ADHESIVE AND APPLICATION THEREOF

(71) Applicants: INTERFACE TECHNOLOGY (CHENGDU) CO., LTD., CHENGDU CITY (CN); INTERFACE OPTOELECTRONICS (SHENZHEN) CO., LTD., SHENZHEN CITY (CN); GENERAL INTERFACE SOLUTION LIMITED, MIAOLI COUNTY (TW)

(72) Inventors: YI-CHEN YANG, SHENZHEN CITY (CN); KUAN-LIANG LIU, SHENZHEN CITY (CN)

(21) Appl. No.: 16/413,364

(22) Filed: May 15, 2019

(30) Foreign Application Priority Data
Jan. 23, 2019 (CN) 201910062502.X

(51) Int. Cl. C09J 7/38; C09J 133/08; C09J 11/04; C09J 11/08

(52) U.S. Cl. CPC C09J 7/385; C09J 133/08; C08K 5/29; C09J 11/08; C09J 11/04

(57) ABSTRACT

The present invention provides a light detectable thermal-release pressure-sensitive adhesive and an application thereof. Heat-expandable foaming particles are added to a formula of the light detectable thermal-release pressure-sensitive adhesive, so that the product has high adhesion; moreover, after curing and molding, the adhesion can be greatly reduced by a heating process, so the problem that the existing high-adhesion pressure-sensitive adhesive film is not torn easily is solved; and meanwhile, by adding an inorganic fluorescent material, the light detectable thermal-release pressure-sensitive adhesive absorbs ultraviolet light and then can emit a visible wavelength to detect adhesive residues quickly; and by applying the light detectable thermal-release pressure-sensitive adhesive to a manufacture procedure, the adhesive residues are not occurred easily and thus the convenience of detecting the adhesive residue is increased.

This application claims priority for China patent application no. 201910062502.X filed on Jan. 23, 2019, the content of which is incorporated by reference in its entirely.

### BACKGROUND OF THE INVENTION

### Field of the Invention

The present invention relates to a pressure-sensitive adhesive and an application thereof, and in particular to a light detectable thermal-release pressure-sensitive adhesive and a light detectable thermal-release pressure-sensitive adhesive film using the light detectable thermal-release pressure-sensitive adhesive and a manufacturing method thereof.

### Description of the Related Art

In recent years, the design trend of a mobile phone, a tablet computer and a notebook computer has changed from a traditional 2D plane design to a 3D curve design, and a pressure-sensitive adhesive for an ordinary manufacture procedure has already failed to meet the requirement of a manufacture procedure in nowadays. In order to overcome the warpage problem of a 3D curve attached to the mobile phone and the tablet computer, it is a common practice to increase the adhesion of an adhesive film. However, such a manner also increases the difficulty of subsequently tearing the film; and as a result, the risks of adhesive residues and film breakage occur in the film tearing and the production efficiency is reduced. Since the tiny adhesive residues are neither cleaned easily nor inspected visually or detected by a Charge Coupled Device (CCD), more quality inspection personnel and detection time are required in a production line and thus the manufacturing cost and production time are increased.

A thermal-release adhesive is one of the pressure-sensitive adhesives, and may be easily stripped only by heating. However, the existing thermal-release adhesive is present in a form of a film material. It is applicable to a 2D or plane product and is difficult to be effectively attached to a product having a 3D curve; and at the edge of the curve, the warpage phenomenon is easily caused. Furthermore, although the film material of the commercially-available thermal-release adhesive may be designed in multiple colors, the pressure-sensitive adhesive is often designed to be transparent or light white; and after a product is heated to relieve the viscosity and remove the pressure-sensitive adhesive film, how to quickly detect whether the adhesive is remained on the surface or not is a challenge still to be overcome.

Therefore, how to design a pressure-sensitive adhesive not having the adhesive residues easily in a manufacture procedure and easily detected in case of the adhesive residues is a problem confronted now in the technical field.

### SUMMARY OF THE INVENTION

In view of this, a main objective of the present invention is to provide a light detectable thermal-release pressure-sensitive adhesive and an application thereof, so that the adhesive residues after a pressure-sensitive film is removed may be reduced and the convenience of detecting the adhesive residues is increased.

To this end, the present invention provides a light detectable thermal-release pressure-sensitive adhesive; and the components in parts by weight include 100 parts (Parts Per Hundreds (PHR)) of main pressure-sensitive adhesive, 0.05-3.0 parts of inorganic fluorescent material, 0.5-3.0 parts of cross-linking agent, 0.5-25 parts of tackifying resin and 5-50 parts of heat-expandable foaming particles. The light detectable thermal-release pressure-sensitive adhesive is a mixture of the above components, the form of the mixture is not limited and the mixture may be a film material or a liquid mixture.

According to the embodiment of the present invention, the main pressure-sensitive adhesive may be selected from a copolymer solution of 2-ethylhexyl acrylate (2-EHA), ethyl acetate (EA), acrylic acid (AA), 2-hydroxyethyl acrylate (2-HEA) and a combination thereof.

According to the embodiment of the present invention, the cross-linking agent may be a polyisocyanate cross-linking agent.

In addition, the present invention further provide a light detectable thermal-release pressure-sensitive adhesive film using the light detectable thermal-release pressure-sensitive adhesive, which includes a base material layer and the light detectable thermal-release pressure-sensitive adhesive disposed on the base material layer.

The present invention further provides a method for manufacturing a light detectable thermal-release pressure-sensitive adhesive film by using the light detectable thermal-release pressure-sensitive adhesive, which includes the steps of first providing the light detectable thermal-release pressure-sensitive adhesive and then coating the light detectable thermal-release pressure-sensitive adhesive on a base material; and thereafter, curing the light detectable thermal-release pressure-sensitive adhesive and molding to obtain the light detectable thermal-release pressure-sensitive adhesive film of the present invention.

According to the embodiment of the present invention, in the step of coating the light detectable thermal-release pressure-sensitive adhesive, the light detectable thermal-release pressure-sensitive adhesive may be coated in a comprehensive coating manner, a discontinuous coating manner or a dot coating manner.

According to the embodiment of the present invention, in the step of curing the light detectable thermal-release pressure-sensitive adhesive and molding, an oven curing method or an ultraviolet curing method may be used.

According to the embodiment of the present invention, after the step of curing the light detectable thermal-release pressure-sensitive adhesive and molding, the method further includes a step of heating the light detectable thermal-release pressure-sensitive adhesive film at 80-180° C. to relieve the viscosity.

According to the embodiment of the present invention, after the step of curing the light detectable thermal-release pressure-sensitive adhesive and molding, the method further includes a step of enabling the light detectable thermal-release pressure-sensitive adhesive film to absorb ultraviolet light to release visible light.

According to the light detectable thermal-release pressure-sensitive adhesive and the application thereof provided by the present invention, with the special formula of the light detectable thermal-release pressure-sensitive adhesive, the high adhesion is achieved; the viscosity can be relieved in a heating manner, so various problems caused by the film tearing difficulty are prevented; and meanwhile, compared with the thermal-release pressure-sensitive adhesive film difficult to quickly detect the adhesive residues in the prior art, the visible light is emitted by the inorganic fluorescent material of the light detectable thermal-release pressure-sensitive adhesive and thus whether the light detectable thermal-release pressure-sensitive adhesive is removed from an attached body completely or not or a part of adhesive is transferred to the attached body or not may be judged. Therefore, the adhesive residues may be removed quickly and effectively, and the manufacturing cost and production time are greatly reduced.

The present invention will be described below in detail in combination with specific embodiments and accompanying drawings to better understand the objectives, technical contents, features and effects of the present invention.

### BRIEF DESCRIPTION OF THE DRAWINGS

FIG. 1 is a flowchart diagram of a method for manufacturing a light detectable thermal-release pressure-sensitive adhesive film according to an embodiment of the present invention.

FIG. 2 is a sectional view of a light detectable thermal-release pressure-sensitive adhesive film according to an embodiment of the present invention.

FIG. 3A and FIG. 3B respectively are a fluorescence diagram of a light detectable thermal-release pressure-sensitive adhesive according to the present invention.

FIG. 4 is a schematic diagram when the viscosity of a light detectable thermal-release pressure-sensitive adhesive in a film material form is not relieved according to the present invention.

FIG. 5 is a schematic diagram when the viscosity of a light detectable thermal-release pressure-sensitive adhesive in a film material form is relieved according to the present invention.

### DETAILED DESCRIPTION OF THE INVENTION

The present invention discloses a light detectable thermal-release pressure-sensitive adhesive, which is a mixture formed by components such as a main pressure-sensitive adhesive, an inorganic fluorescent material, a cross-linking agent, a tackifying resin and heat-expandable foaming particles. For composing proportions of these components, based on 100 parts by weight (PHR) of main pressure-sensitive adhesive, the usage amount of the inorganic fluorescent material is 0.05-30 parts, the usage amount of the cross-linking agent is 0.5-3.0 parts, the usage amount of the tackifying resin is 0.5-25 parts and the usage amount of the heat-expandable foaming particles is 5-50 parts. In the main pressure-sensitive adhesive, the solvent is 50-70% of the whole components. The PHR is an abbreviation of parts per hundreds, and represents the usage in each 100 parts by weight.

Specifically, the main pressure-sensitive adhesive may be selected from a copolymer solution of 2-ethylhexyl acrylate (2-EHA), ethyl acetate (EA), acrylic acid (AA), 2-hydroxyethyl acrylate (2-HEA) and a combination thereof. The cross-linking agent may be a polyisocyanate cross-linking agent, such as an isocyanate trimer having a product model of Coronate L.

In the present invention, the light detectable thermal-release pressure-sensitive adhesive is not limited in a form and may be present in a form of a film material or a liquid mixture and the like.

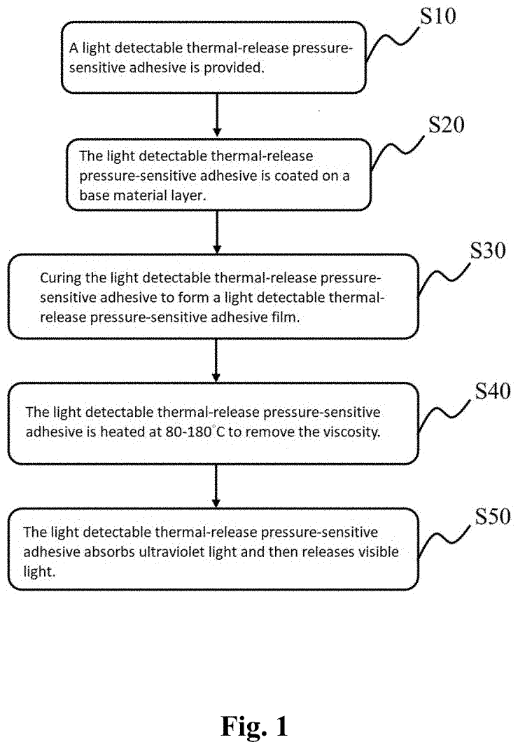

Further, the present invention discloses a light detectable thermal-release pressure-sensitive adhesive film using the light detectable thermal-release pressure-sensitive adhesive and a manufacturing method thereof. Referring to FIG. 1, a method for manufacturing a light detectable thermal-release pressure-sensitive adhesive film in this embodiment of the present invention includes the following steps.

First of all, as mentioned in the step S10, a light detectable thermal-release pressure-sensitive adhesive is provided. In this embodiment, the light detectable thermal-release pressure-sensitive adhesive is prepared by mixing components in the following steps.

1. 100 parts by weight of main pressure-sensitive adhesive are mixed with 0.0.5-3.0 parts by weight of inorganic fluorescent material to form a first mixture.

2. The first mixture is mixed with an appropriate amount of tackifying resin to form a second mixture.

3. The second mixture is mixed with an appropriate amount of heat-expandable foaming particles to form a third mixture.

4. The third mixture is mixed with 0.5-3.0 parts by weight of cross-linking agent according to an appropriate proportion to complete the preparation of the light detectable thermal-release pressure-sensitive adhesive.

In this embodiment, the composing proportion of each component of the light detectable thermal-release pressure-sensitive adhesive may be prepared according to an actual demand. Herein, a preferable composing proportion is provided. Based on 100 parts by weight of main pressure-sensitive adhesive, the usage amount of the inorganic fluorescent material is 1 part, the usage amount of the cross-linking agent is 2 parts, the usage amount of the tackifying resin is 15 parts and the usage amount of the heat-expandable foaming particles is 25 parts.

As mentioned in step S20, the light detectable thermal-release pressure-sensitive adhesive is coated on a base material layer. The coating manner may be, for example, a comprehensive coating manner, a discontinuous coating manner or a dot coating manner.

In this embodiment, the step S20 is to coat 22 μm light detectable thermal-release pressure-sensitive adhesive on a base material layer of a 38 μm polyester film by using a scraper.

As mentioned in S30, the light detectable thermal-release pressure-sensitive adhesive is cured to obtain the light detectable thermal-release pressure-sensitive adhesive film of the present invention. The curing method may be, for example, an oven curing method or an ultraviolet curing method. Further, if the light detectable thermal-release pressure-sensitive adhesive film is of a solvent type, the adhesive may be cured at <80° C. by using a drying oven; and if the light detectable thermal-release pressure-sensitive adhesive film is of a non-solvent type, the adhesive may be cured by using ultraviolet light having the wavelength less than 400 nm.

In this embodiment, the coated light detectable thermal-release pressure-sensitive adhesive is placed into the drying oven at 80° C. for 2 min and is attached with a release film; and at last, the finished product is placed into a room temperature environment for 7 days.

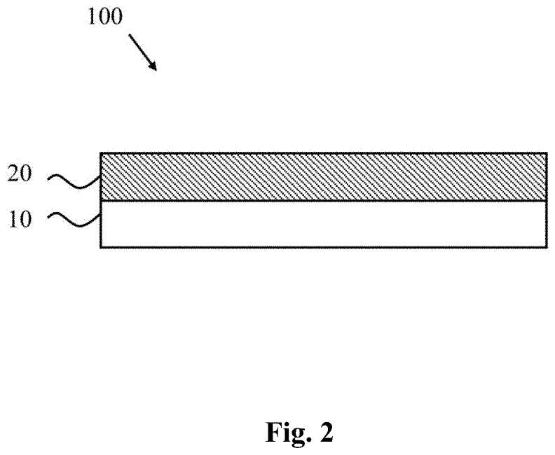

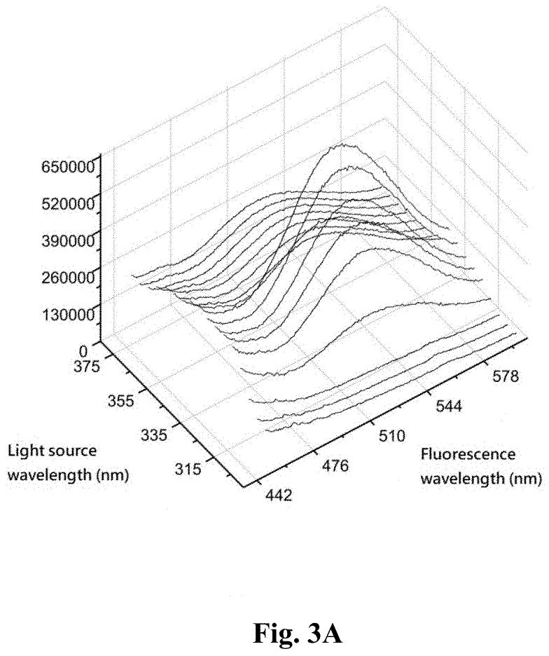

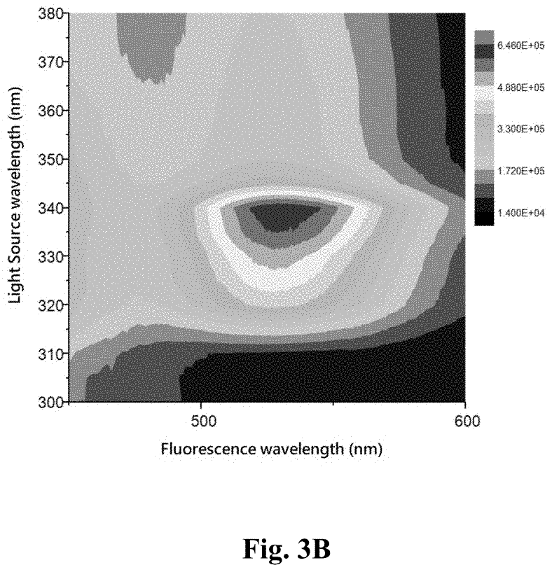

Referring to FIG. 2, a light detectable thermal-release pressure-sensitive adhesive film 100 prepared in this embodiment of the present invention includes a base material layer 10 and a light detectable thermal-release pressure-sensitive adhesive 20 disposed on the base material layer 10. Through analysis of a fluorescence spectrophotometer on the light detectable thermal-release pressure-sensitive adhesive 20 of the present invention, as shown by the spectrogram in FIG. 3A and FIG. 3B, the light detectable thermal-release pressure-sensitive adhesive 20 has a strong fluorescence reaction at a 500-550 nm wavelength.

In addition, as mentioned in the step S40, for the cured light detectable thermal-release pressure-sensitive adhesive film 100 of the present invention, the viscosity of the adhesive may further be relieved in a heating manner. By heating the light detectable thermal-release pressure-sensitive adhesive 20 to 80-180° C., the viscosity may be completely relieved.

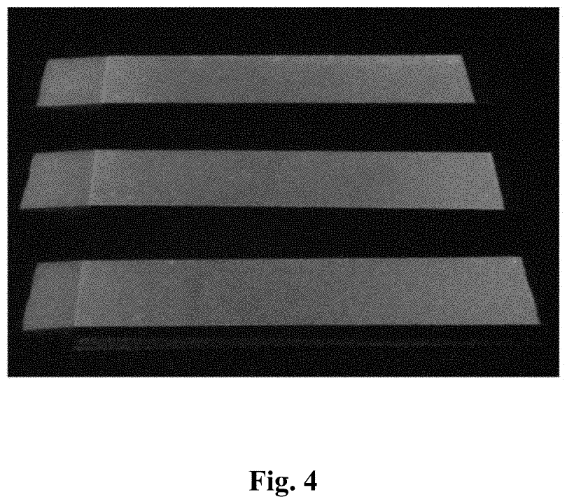

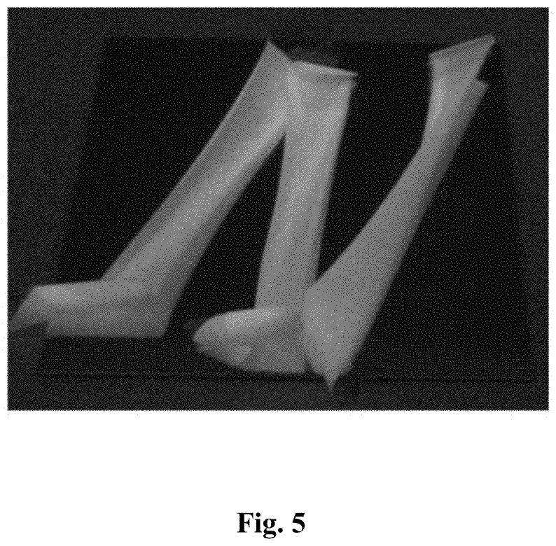

In one embodiment of the present invention, the light detectable thermal-release pressure-sensitive adhesive in the film material form is placed onto a glass substrate, and the light detectable thermal-release pressure-sensitive adhesive is irradiated with ultraviolet light having a 365 nm wavelength to cure the surface. As shown in FIG. 4, a viscous state of the light detectable thermal-release pressure-sensitive adhesive is not relieved. Then, the viscosity of the light detectable thermal-release pressure-sensitive adhesive is relieved by heating at 100° C. As shown in FIG. 5, the viscous state of the light detectable thermal-release pressure-sensitive adhesive 20 is relieved.

At last, as mentioned in the step S50, whether the light detectable thermal-release pressure-sensitive adhesive is completely removed from the glass substrate or not may be inspected visually.

In conclusion, according to the light detectable thermal-release pressure-sensitive adhesive and the light detectable thermal-release pressure-sensitive adhesive film using the light detectable thermal-release pressure-sensitive adhesive and the manufacturing method provided by the present invention, by adding the heat-expandable foaming particles to the formula of the light detectable thermal-release pressure-sensitive adhesive, the product has high adhesion; and moreover, through a simple heating procedure, the adhesion may be greatly reduced, and the phenomena of adhesive residues and film breakage easily generated because the existing high-adhesion pressure-sensitive adhesive film is not easily torn are reduced.

Furthermore, by virtue of the own inorganic fluorescent material of the light detectable thermal-release pressure-sensitive adhesive, the light detectable thermal-release pressure-sensitive adhesive may absorb the ultraviolet light (the wavelength is smaller than 400 nm) and then emits visible light (the wavelength is 490-700 nm), so that whether the light detectable thermal-release pressure-sensitive adhesive exists or not, i.e., whether the light detectable thermal-release pressure-sensitive adhesive is completely removed from an attached body or not, or whether a part of light detectable thermal-release pressure-sensitive adhesive is transferred to the attached body or not, may be known by using any light detection method or directly visual inspection method. Therefore, the convenience of detecting the adhesive residues may be increased, and the adhesive residues can be quickly and effectively removed; and by applying the light detectable thermal-release pressure-sensitive adhesive to a manufacture procedure, the adhesive residues are not occurred easily, and the manufacturing cost and production time are greatly reduced.

The above embodiments only illustrate the technical concepts and features of the present invention and are intended to enable a person skilled in the art to understand the contents of the present invention and implement thereto but not limit the scope of the present invention. Any change or modification made within the spirit of the present invention should be included in the scope of the present invention.

What is claimed is:

1. A light detectable thermal-release pressure-sensitive adhesive, being a mixture of the following components, the components in parts by weight comprising:
100 parts of main pressure-sensitive adhesive;
0.05-3.0 parts of inorganic fluorescent material;
0.5-3.0 parts of cross-linking agent;
0.5-25 parts of tackifying resin; and
5-50 parts of heat-expandable foaming particles.

2. The light detectable thermal-release pressure-sensitive adhesive according to claim 1, wherein the main pressure-sensitive adhesive is selected from a copolymer solution of 2-ethylhexyl acrylate (2-EHA), ethyl acetate (EA), acrylic acid (AA), 2-hydroxyethyl acrylate (2-HEA) and a combination thereof.

3. The light detectable thermal-release pressure-sensitive adhesive according to claim 1, wherein the cross-linking agent is a polyisocyanate cross-linking agent.

4. The light detectable thermal-release pressure-sensitive adhesive according to claim 1, wherein based on 100 parts by weight of the main pressure-sensitive adhesive, the adhesive comprises 1 part of inorganic fluorescent material, 2 parts of cross-linking agent, 15 parts of tackifying resin and 25 parts of heat-expandable foaming particles.

5. A light detectable thermal-release pressure-sensitive adhesive film, comprising:
a base material layer; and
the light detectable thermal-release pressure-sensitive adhesive according to claim 1, disposed on the base material layer.

6. A method for manufacturing a light detectable thermal-release pressure-sensitive adhesive film, comprising the steps of:
providing the light detectable thermal-release pressure-sensitive adhesive according to claim 1;
coating the light detectable thermal-release pressure-sensitive adhesive on a base material layer; and
curing the light detectable thermal-release pressure-sensitive adhesive to form the light detectable thermal-release pressure-sensitive adhesive film.

7. The method for manufacturing the light detectable thermal-release pressure-sensitive adhesive film according to claim 6, wherein the step of providing the light detectable thermal-release pressure-sensitive adhesive comprises:
mixing 100 parts by weight (Parts Per Hundreds (PHR)) of main pressure-sensitive adhesive with 0.05-3.0 parts by weight of inorganic fluorescent material to form a first mixture;
mixing the first mixture with a tackifying resin to form a second mixture;
mixing the second mixture with heat-expandable foaming particles to form a third mixture; and
mixing the third mixture with 0.5-3.0 parts by weight of cross-linking agent to form the light detectable thermal-release pressure-sensitive adhesive.

8. The method for manufacturing the light detectable thermal-release pressure-sensitive adhesive film according to claim 6, wherein in the step of coating the light detectable thermal-release pressure-sensitive adhesive, the light detectable thermal-release pressure-sensitive adhesive is coated in a comprehensive coating manner, a discontinuous coating manner or a dot coating manner.

9. The method for manufacturing the light detectable thermal-release pressure-sensitive adhesive film according to claim 6, wherein after the step of curing the light detectable thermal-release pressure-sensitive adhesive, the method further comprises a step of heating the light detectable thermal-release pressure-sensitive adhesive at 80-180° C. to relieve the viscosity.

10. The method for manufacturing the light detectable thermal-release pressure-sensitive adhesive film according to claim 6, wherein after the step of curing the light detectable thermal-release pressure-sensitive adhesive, the method further comprises a step of enabling the light detectable thermal-release pressure-sensitive adhesive to absorb ultraviolet light to release visible light.
